(19) United States
(12) Patent Application Publication
(10) Pub. No.: US 2010/0032475 A1
(43) Pub. Date: Feb. 11, 2010

(54) COVERED CONTAINER FOR ENCLOSING A FOOD PRODUCT OR THE LIKE

(76) Inventor: Jack BURTON, Reno, TX (US)

Correspondence Address: Clements Bernard PLLC, 1901 Roxborough Road, Suite 250, Charlotte, NC, 28211, US

(21) Appl. No.: 12/537,765

(22) Filed: Aug. 7, 2009

Related U.S. Application Data
(60) Provisional application No. 61/087,300, filed on Aug. 8, 2008.

(51) Int. Cl. B65D 5/20; B31B 49/02

(52) U.S. Cl. 229/150; 493/162

(57) ABSTRACT

The present invention provides a container configured to selectively enclose a food product or the like, including: a tray including a first side wall, a second side wall, a front wall, a back wall, and a bottom that collectively define a compartment configured to hold a food product or the like, wherein the first side wall and the second side wall each include an enlarged flap; and a tapered cover including a first side wall, a second side wall, a front wall, a back wall, and a tapered top, wherein the first side wall, the second side wall, the front wall, the back wall, and the top are substantially coextensive with the tray, and wherein the first side wall and the second side wall each include an enlarged flap that is configured and positioned to interlock with the corresponding enlarged flap of the first side wall and the second side wall of the tray.

### CROSS-REFERENCE TO RELATED APPLICATION(S)

The present non-provisional patent application/patent claims the benefit of priority of U.S. Provisional Patent Application No. 61/087,300, filed on Aug. 8, 2008, and entitled “COVERED CONTAINER FOR ENCLOSING A FOOD PRODUCT OR THE LIKE,” the contents of which are incorporated in full by reference herein.

### FIELD OF THE INVENTION

The present invention relates generally to a covered container for enclosing a food product or the like. More specifically, the present invention relates to a folded paperboard, corrugated, or foam container or the like having a tapered cover and interlocking tray for enclosing a food product or the like.

### BACKGROUND OF THE INVENTION

Folded paperboard, corrugated, and foam containers are often used in the fast food/quick serve restaurant industry. Advantageously, such containers are relatively simple and inexpensive to manufacture, ship, store, assemble, and use, and are typically disposable. Often, it is desirable for these containers to be stacked when full, requiring a certain degree of structural integrity.

Conventional folded paperboard, corrugated, and foam containers have inadequate structural integrity. Typically, these containers have a cover that is hingedly connected to a tray, the cover closely resembling the tray, built with the sides and front of the cover slightly overlapping the sides and front of the tray. The front of the cover is selectively secured to the front of the tray via a tab and slot mechanism, for example. Essentially, structural integrity is provided only by the front and back of the tray and cover.

Thus, what is still needed in the art is a folded paperboard, corrugated, or foam container or the like that has adequate structural integrity, such that it may be stacked, etc. Preferably, this container would be relatively simple in design and inexpensive to manufacture. Folded paperboard, corrugated, and foam containers and the like are single-use items that are used by the thousands. Thus, incremental increases in material, handling, and use efficiency may lead to significant savings and/or market penetration.

### BRIEF SUMMARY OF THE INVENTION

As described above, the present invention relates generally to a covered container for enclosing a food product or the like. More specifically, the present invention relates to a folded paperboard, corrugated, or foam container or the like having a tapered cover and interlocking tray for enclosing a food product or the like.

In one exemplary embodiment, the present invention provides a container configured to selectively enclose a food product or the like, including: a tray including a first side wall, a second side wall, a front wall, a back wall, and a bottom that collectively define a compartment configured to hold a food product or the like, wherein the first side wall and the second side wall each include an enlarged flap; and a tapered cover including a first side wall, a second side wall, a front wall, a back wall, and a tapered top, wherein the first side wall, the second side wall, the front wall, the back wall, and the top are substantially coextensive with the tray, and wherein the first side wall and the second side wall each include an enlarged flap that is configured and positioned to interlock with the corresponding enlarged flap of the first side wall and the second side wall of the tray. Each of the enlarged flaps of the tray is disposed substantially adjacent to the front wall of the tray and opposite the bottom. Each of the enlarged flaps of the tray includes one or more of substantially straight features, substantially arcuate features, ridges, and notches. Each of the enlarged flaps of the tapered cover is disposed substantially adjacent to the back wall of the tapered cover and opposite the top. Each of the enlarged flaps of the tapered cover includes one or more of substantially straight features, substantially arcuate features, ridges, and notches.

In another exemplary embodiment, the present invention provides a method for providing a container configured to selectively enclose a food product or the like, including: providing a tray including a first side wall, a second side wall, a front wall, a back wall, and a bottom that collectively define a compartment configured to hold a food product or the like, wherein the first side wall and the second side wall each include an enlarged flap; and providing a tapered cover including a first side wall, a second side wall, a front wall, a back wall, and a tapered top, wherein the first side wall, the second side wall, the front wall, the back wall, and the top are substantially coextensive with the tray, and wherein the first side wall and the second side wall each include an enlarged flap that is configured and positioned to interlock with the corresponding enlarged flap of the first side wall and the second side wall of the tray. Each of the enlarged flaps of the tray is disposed substantially adjacent to the front wall of the tray and opposite the bottom. Each of the enlarged flaps of the tray includes one or more of substantially straight features, substantially arcuate features, ridges, and notches. Each of the enlarged flaps of the tapered cover is disposed substantially adjacent to the back wall of the tapered cover and opposite the top. Each of the enlarged flaps of the tapered cover includes one or more of substantially straight features, substantially arcuate features, ridges, and notches.

### BRIEF DESCRIPTION OF THE DRAWINGS

The present invention is illustrated and described herein with reference to the various drawings, in which like reference numbers are used to denote like container components/method steps, as appropriate, and in which:

FIG. 1 is a perspective view of one exemplary embodiment of the container of the present invention in an open configuration, highlighting the tapered cover and interlocking tray;

FIG. 2 is a perspective view of the container of FIG. 1 in a closed configuration, again highlighting the tapered cover and interlocking tray;

FIG. 3 is a planar front view of the container of FIGS. 1 and 2;

FIG. 4 is a planar side view of the container of FIGS. 1-3;

FIG. 5 is a planar top view of the container of FIGS. 1-4; and

FIG. 6 is a planar top view of the container of FIGS. 1-5 in an unassembled configuration, highlighting the components of the tapered cover and interlocking tray.

### DETAILED DESCRIPTION OF THE INVENTION

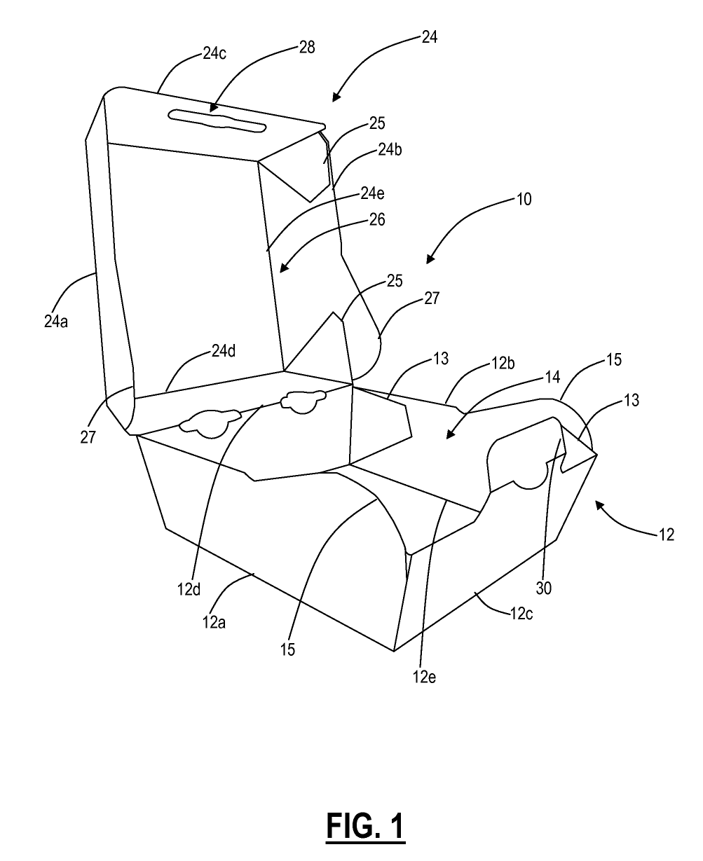

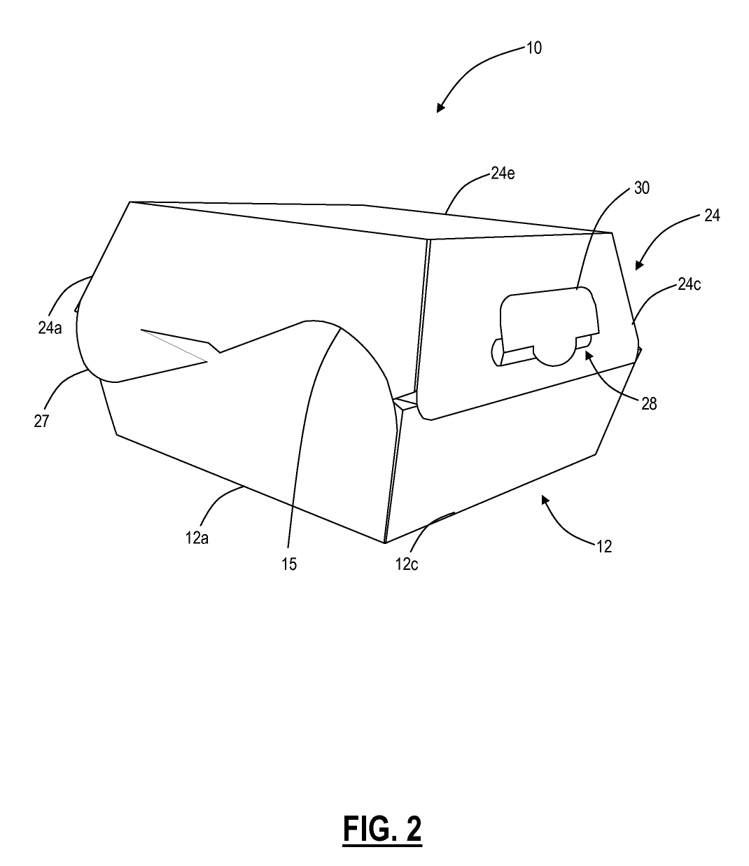

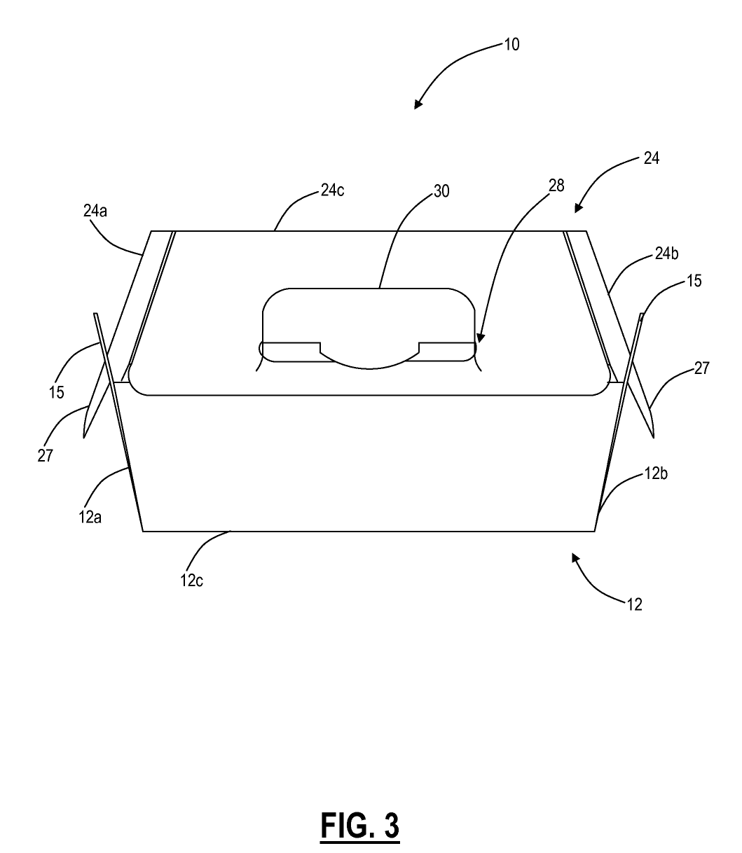

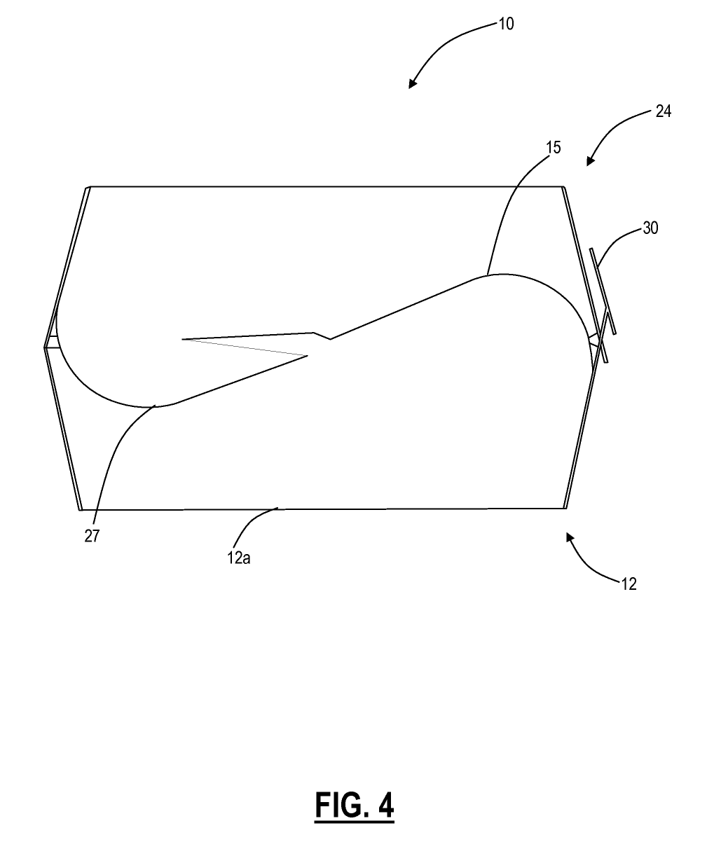

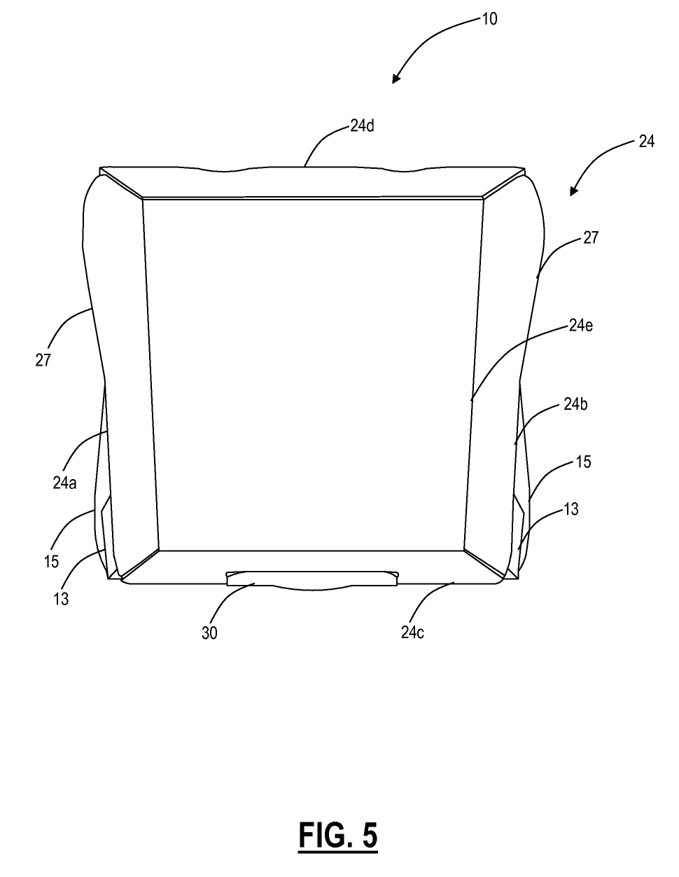

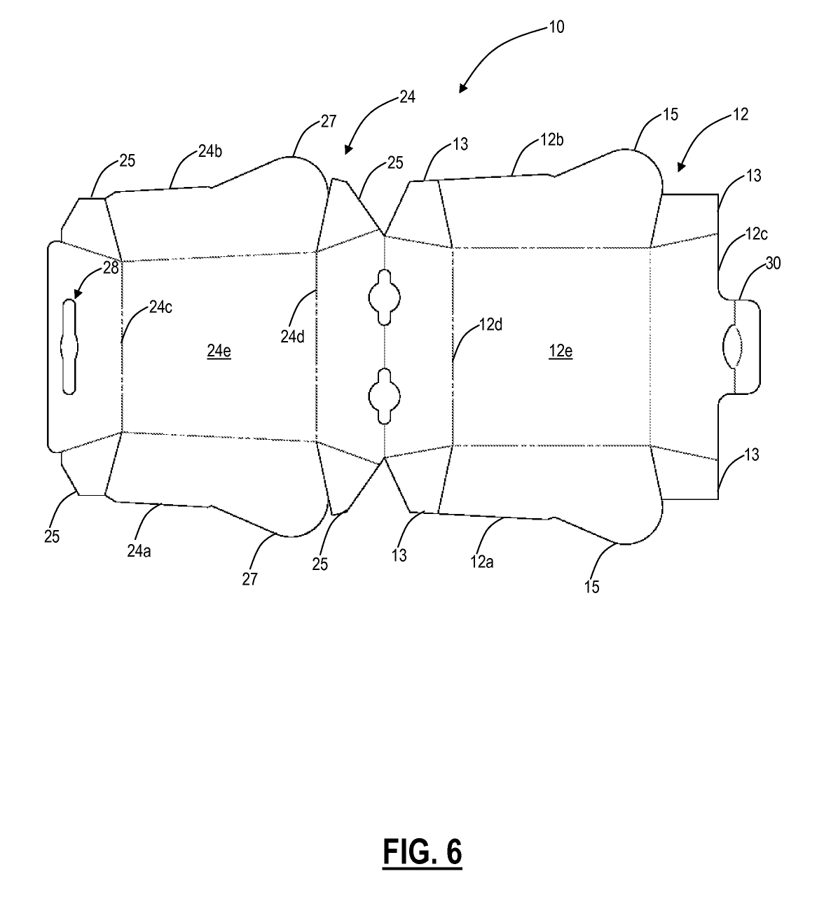

Referring to FIGS. 1-6, in one exemplary embodiment, the container 10 of the present invention includes a tray 12 that is constructed from a first side wall 12a, a second side wall 12b, a front wall 12c, a back wall 12d, and a bottom 12e. Each of these components is made of paperboard, corrugated cardboard, styrofoam, or another suitable packaging material for food products or the like. This packaging material may be substantially, rigid, semi-rigid, or flexible, and may be dyeable, moisture resistant, heatable, etc. The first side wall 12a, the second side wall 12b, the front wall 12c, and the back wall 12d are each integrally formed with or substantially inseparable from the bottom 12e along multiple folds or joints. The first side wall 12a, the second side wall 12b, the front wall 12c, and the back wall 12d are connected to one another via multiple tabs 13 and corresponding slots (not illustrated) and/or an adhesive, or via a flexure joint or the like, such that the first side wall 12a, the second side wall 12b, the front wall 12c, the back wall 12d, and the bottom 12e collectively form a prismatic compartment 14 suitable for containing and holding a food product or the like. Preferably, the first side wall 12a and the second side wall 12b each include an enlarged flap 15 substantially adjacent to the front wall 12c and opposite the bottom 12e. These enlarged flaps 15 may include one or more substantially straight and/or substantially arcuate features, as well as one or more ridges and/or notches. The functionality of these enlarged flaps 15 is described in greater detail below.

The container 10 also includes a tapered cover 24 that selectively encloses the compartment 24 of the tray 12. The tapered cover 24 is constructed from a first side wall 24a, a second side wall 24b, a front wall 24c, a back wall 24d, and a top 24e. Each of these components is made of paperboard, corrugated cardboard, styrofoam, or another suitable packaging material for food products or the like. This packaging material may be substantially, rigid, semi-rigid, or flexible, and may be dyeable, moisture resistant, heatable, etc. The first side wall 24a, the second side wall 24b, the front wall 24c, and the back wall 24d are each integrally formed with or substantially inseparable from the top 24e along multiple folds or joints. The first side wall 24a, the second side wall 24b, the front wall 24c, and the back wall 24d are connected to one another via multiple tabs 25 and corresponding slots (not illustrated) and/or an adhesive, or via a flexure joint or the like, such that the first side wall 24a, the second side wall 24b, the front wall 24c, the back wall 24d, and the top 24e collectively form a prismatic compartment 26 that is substantially coextensive with the compartment 14 of the tray 12. Preferably, the top 24e of the tapered cover 24 is substantially tapered from the back wall 24d to the front wall 24c of the tapered cover 24. The front wall 24c of the tapered cover 24 includes a slot 28 that is configured to selectively engage a corresponding tab 30 associated with the front wall 12c of the tray 12 when the tapered cover 24 is closed, providing a sturdy closure. Preferably, the first side wall 24a and the second side wall 24b each include an enlarged flap 27 substantially adjacent to the back wall 24d and opposite the top 24e. These enlarged flaps 27 may include one or more substantially straight and/or substantially arcuate features, as well as one or more ridges and/or notches. These enlarged flaps 27 of the tapered cover 24 are configured and positioned to engage and nest with the enlarged flaps 15 of the tray 12 when the tapered cover 24 is closed. The tapered cover 24 is coupled to the tray 12 via a fold hinge or the like between the back wall 24c of the tapered cover 24 and the back wall 12c of the tray 12, which may be integrally formed or substantially inseparable.

Advantageously, the taper of the top 24e and the interlocking enlarged flaps 15 and 27 provide the container 10 with enhanced structural strength and integrity, such that multiple containers 10 may be stacked and manipulated without damage. Essentially, structural integrity is provided by the front walls 12c and 24c, back walls 12d and 24d, and side walls 12a, 12b, 24a, and 24b of the tray 12 and tapered cover 24. Structural integrity is also provided by the fact that the front wall 24c of the tapered cover 24 rests on the front wall 12c of the tray 12 when the tapered cover 24 is closed.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A container configured to selectively enclose a food product or the like, comprising:
a tray comprising a first side wall, a second side wall, a front wall, a back wall, and a bottom that collectively define a compartment configured to hold a food product or the like, wherein the first side wall and the second side wall each comprise an enlarged flap; and
a tapered cover comprising a first side wall, a second side wall, a front wall, a back wall, and a tapered top, wherein the first side wall, the second side wall, the front wall, the back wall, and the top are substantially coextensive with the tray, and wherein the first side wall and the second side wall each comprise an enlarged flap that is configured and positioned to interlock with the corresponding enlarged flap of the first side wall and the second side wall of the tray.

2. The container of claim 1, wherein each of the enlarged flaps of the tray is disposed substantially adjacent to the front wall of the tray and opposite the bottom.

3. The container of claim 1, wherein each of the enlarged flaps of the tray comprises one or more of substantially straight features, substantially arcuate features, ridges, and notches.

4. The container of claim 1, wherein each of the enlarged flaps of the tapered cover is disposed substantially adjacent to the back wall of the tapered cover and opposite the top.

5. The container of claim 1, wherein each of the enlarged flaps of the tapered cover comprises one or more of substantially straight features, substantially arcuate features, ridges, and notches.

6. A method for providing a container configured to selectively enclose a food product or the like, comprising:
providing a tray comprising a first side wall, a second side wall, a front wall, a back wall, and a bottom that collectively define a compartment configured to hold a food product or the like, wherein the first side wall and the second side wall each comprise an enlarged flap; and
providing a tapered cover comprising a first side wall, a second side wall, a front wall, a back wall, and a tapered top, wherein the first side wall, the second side wall, the front wall, the back wall, and the top are substantially coextensive with the tray, and wherein the first side wall and the second side wall each comprise an enlarged flap that is configured and positioned to interlock with the corresponding enlarged flap of the first side wall and the second side wall of the tray.

7. The method of claim 6, wherein each of the enlarged flaps of the tray is disposed substantially adjacent to the front wall of the tray and opposite the bottom.

8. The method of claim 6, wherein each of the enlarged flaps of the tray comprises one or more of substantially straight features, substantially arcuate features, ridges, and notches.

9. The method of claim 6, wherein each of the enlarged flaps of the tapered cover is disposed substantially adjacent to the back wall of the tapered cover and opposite the top.

10. The method of claim 6, wherein each of the enlarged flaps of the tapered cover comprises one or more of substantially straight features, substantially arcuate features, ridges, and notches.
